(19) United States
(12) Patent Application Publication
(10) Pub. No.: US 2007/0004844 A1
(43) Pub. Date: Jan. 4, 2007

(54) Dielectric material

(76) Inventors: Robert S. Clough, St. Paul, MN (US); Fuming B. Li, Woodbury, MN (US); Mary J. Swierczek, Oakdale, MN (US); Bradley L. Givot, St. Paul, MN (US)

Correspondence Address: 3M INNOVATIVE PROPERTIES COMPANY, PO BOX 33427, ST. PAUL, MN, 55133-3427, US

(21) Appl. No.: 11/170,932

(22) Filed: Jun. 30, 2005

(51) Int. Cl. C08K 3/34

(52) U.S. Cl. 524/493; 524/565

(57) ABSTRACT

A composition comprising a mixture of about 9 to about 20 wt % poly(acrylonitrile-co-butadiene) and about 80 to about 91 wt % cyanate ester of the total weight of the poly(acrylonitrile-co-butadiene) and cyanate ester. Also, an article comprising a cured mixture having a continuous phase comprising poly(acrylonitrile-co-butadiene) and a discrete or co-continuous phase comprising cyanate ester.

### TECHNICAL FIELD

This invention relates to dielectric materials suitable for use in electronic articles and articles made with such dielectric materials.

### BACKGROUND

Advanced high density, multilayer electronic packages require advanced dielectric materials, especially for the high frequency (GHz) applications. One of the key properties for such advanced dielectrics is the low dielectric loss in the GHz frequency range, where associated signal loss becomes a key performance roadblock. Another key requirement is that the glass transition temperature (T_{g}) of the dielectric materials must be sufficiently high, e.g., higher than 200° C., to survive increasing high temperature manufacturing processes, such as lead-free solder reflow. Toughness of the dielectric is desired to inhibit crack formation when the package is subjected to mechanical and thermal stresses. A dielectric material with low coefficient of thermal expansion (CTE), e.g., a CTE close to that of copper (CTE of 17 parts per million (ppm)/° C.), is desirable to reduce stresses that result from CTE mismatch.

### SUMMARY

One aspect of the present invention features a composition comprising a mixture of about 9 to about 20 wt % poly(acrylonitrile-co-butadiene) and about 80 to about 91 wt % cyanate ester of the total weight of the poly(acrylonitrile-co-butadiene) and cyanate ester.

Another aspect of the present invention features an article comprising a cured mixture having a continuous phase comprising poly(acrylonitrile-co-butadiene) and a discrete or co-continuous phase comprising cured cyanate ester.

Another aspect of the present invention features an article comprising at least one dielectric layer comprising a cured mixture having a continuous phase comprising poly(acrylonitrile-co-butadiene) and a discrete or co-continuous phase comprising cured cyanate ester.

As used in this invention:

“CTE” refers to the coefficient of thermal expansion of a material. The term “low CTE” means having an isotropic CTE of less than 40 ppm/° C. up to a temperature of about 200° C.;

“low profile” means having a surface roughness, with a maximum foil profile variation (R_{z}) of less than about 10.2 μm (about 400 microinches);

“highly filled” refers to loading of the dielectric material with an inorganic filler at levels greater than or equal to about 50 wt. %; and

“coating” and “layer” are used interchangeably herein.

An advantage of at least one embodiment of the present invention is a dielectric material that has excellent dielectric, mechanical, thermal, and thermomechanical properties.

Another advantage is that the flexibility (toughness) of the dielectric material is superior to cyanate ester materials and cyanate ester materials that have been toughened by discrete, rubber phases; in addition, good mechanical properties are maintained up to the Tg of the pure cyanate ester.

Other features and advantages of the invention will be apparent from the following drawings, detailed description, and claims.

### BRIEF DESCRIPTION OF DRAWINGS

FIG. 1 is a cross-sectional side view illustration of an exemplary multilayer interconnect substrate of an embodiment of the current invention.

FIG. 2 is a cross-sectional side view illustration of an exemplary multi-layer interconnect substrate of an embodiment of the current invention.

FIG. 3 shows a digital scanning electron micrograph image of a cured material having 5 wt % poly(acrylonitrile-co-butadiene) polymer.

FIG. 4 shows a digital scanning electron micrograph image of a cured material having 8 wt % poly(acrylonitrile-co-butadiene) polymer.

FIG. 5 shows a digital scanning electron micrograph image of a cured material of the present invention having 9 wt % poly(acrylonitrile-co-butadiene) polymer.

FIG. 6 shows a digital scanning electron micrograph image of a cured material of the present invention having 10 wt % poly(acrylonitrile-co-butadiene) polymer.

FIG. 7 shows a digital scanning electron micrograph image of a cured material of the present invention having 10 wt % poly(acrylonitrile-co-butadiene) polymer.

FIG. 8 shows tensile storage modulus (E′) and loss modulus (E″) vs. temperature for a cured material of the present invention having 10 wt % poly(acrylonitrile-co-butadiene) polymer.

FIG. 9 shows a digital scanning electron micrograph image of a cured material of the present invention having 20 wt % poly(acrylonitrile-co-butadiene) polymer

FIG. 10 Dimensional change vs. temperature for cured material of the present invention having 10 wt % poly(acrylonitrile-co-butadiene) polymer.

FIG. 11 shows a digital scanning electron micrograph image of a cured material of the present invention having 10 wt % poly(acrylonitrile-co-butadiene) polymer.

FIG. 12 shows a digital scanning electron micrograph image of a cured material of the present invention having 20 wt % poly(acrylonitrile-co-butadiene) polymer.

### DETAILED DESCRIPTION

The cured material of the present invention has excellent dielectrical, thermal, and mechanical properties. The composition of the present invention, which forms the cured material may be coated directly onto copper, or other, substrates. These coated substrates are suitable for use in electronic packages. The term “cured” refers to a material of the present invention in which at least half the cyanate ester functional groups, —OCN, have reacted; preferably at least 90% have reacted; and most preferably at least 95% have reacted.

Thermomechanical properties of the materials are important because of the severe temperature extremes and resultant stresses an electronic package encounters during assembly of the electronic package itself, attachment of electronic components to the package, and in its intended end use. In addition to thermomechanical properties, the dielectric properties of the materials are important in high frequency applications because dielectric materials with lower dielectric loss tangents afford lower power loss, which can be critical in high frequency applications since power loss is typically proportional to frequency.

At least one embodiment of the invention is a cured dielectric material containing a cured cyanate ester and a poly(acrylonitrile-co-butadiene) polymer in which the poly(acrylonitrile-co-butadiene) and some of the cyanate ester forms a continuous phase and the remainder of the cyanate ester forms a co-continuous or discrete phase.

At least one embodiment of the current invention is a composition containing an organic resin including about 80 to about 91 wt.% of a cyanate ester and about 9 to about 20 wt. % of a poly(acrylonitrile-co-butadiene) polymer. The poly(acrylonitrile-co-butadiene) polymer is typically a high molecular weight polymer, which is an elastomeric solid at room temperature.

Prior to being cured, the composition appears to exist in a single phase. Upon curing, the system phase separates into a continuous phase and a co-continuous or discrete phase. The continuous phase may contain substantial amounts of both cyanate ester and poly(acrylonitrile-co-butadiene). The co-continuous or discrete phase is principally cyanate ester and may contain a small amount of poly(acrylonitrile-co-butadiene).

The composition of the present invention is useful as a coating on copper foil to form a resin-coated copper foil (RCC). When the resin composition is cured, the dielectric material forms an insulating layer with a low dielectric loss tangent of less than 0.015 and a high glass transition temperature very near to, or the same as, that of the pure, cured cyanate ester. Filling the resin with appropriate fillers, such as silica, further lowers the dielectric loss tangent to less than 0.008 and provides a CTE of less than 25 ppm/° C. These properties are beneficial for insulation of metal conductors in high frequency applications. The composition of the present invention provides toughness, low dielectric loss, and low CTE.

With regard to weight percentages, the range of about 80 to about 91 wt. % cyanate ester and about 9 to about 20 wt. % high molecular weight poly(acrylonitrile-co-butadiene) based on the combined weight of the cyanate ester and poly(acrylonitrile-co-butadiene) is preferred. Below about 9 wt. % poly(acrylonitrile-co-butadiene), the cured organic resin is fairly stiff and brittle as in the case of pure cyanate ester. Absent other factors that could modify the suitable range, when the poly(acrylonitrile-co-butadiene) content is raised to about 9 wt. % or greater, the cured resin becomes surprisingly flexible. This increased flexibility appears to be due to a morphological change in the cured resin. At less than about 9 wt. % poly(acrylonitrile-co-butadiene), the cured resin composition has a two-phase morphology with a continuous cyanate ester phase and a discrete poly(acrylonitrile-co-butadiene) or poly(acrylonitrile-co-butadiene)/cyanate ester phase. As the percentage of poly(acrylonitrile-co-butadiene) increases to about 9 wt. % or above, a phase inversion occurs in the cured material, and the poly(acrylonitrile-co-butadiene)/cyanate ester phase becomes the continuous phase and the cyanate ester phase becomes the discrete phase. This latter morphology provides for much more flexibility and toughness.

The composition may optionally contain inorganic particulate filler. The choice of filler will be dependent on the intended application of the dielectric material. When the principal role of the material is to insulate electrical conductors and minimize power loss and reduce crosstalk between conductors, in general, useful fillers include inorganic fillers having dielectric constants of less than 5 and dielectric loss (in GHz range) of less than 0.002. Any particulate filler with these properties is useful. Preferably the particulate filler has a median diameter less than about 5 microns or about 25 microns absolute size, has good insulative properties, and/or good dielectric properties. The filler preferably has an average particle size of less than or equal to ten percent of the layer thickness of the dielectric material in the final product. The filler also preferably has a dielectric constant of less than or equal to 4.0, and a dielectric loss of less than 0.001, as does silica. In addition to silica, other suitable inorganic fillers include, but are not limited to, alumina, quartz, and glass. These fillers may generally be added in the amount of about 0 to about 90 wt %. Other types of inorganic particles may be added, for example, to increase heat conductivity, electrical conductivity, or permittivity.

While the addition of poly(acrylonitrile-co-butadiene) to cyanate ester increases the flexibility and toughness of the cyanate ester, it also increases the CTE and dielectric loss tangent. This is undesirable in some situations. However, if the composition is highly filled with an inorganic particulate filler such as silica, the amount of poly(acrylonitrile-co-butadiene) does not have a significant impact on the CTE of the composition in the range of 0 to about 20 wt. % based on the total weight of poly(acrylonitrile-co-butadiene) and cyanate ester. Also, the dielectric loss tangent of a silica-filled composite can be maintained at quite low levels in the 0 to 20 wt. % range.

As the relative amount of poly(acrylonitrile-co-butadiene) is increased in relation to cyanate ester, the volume percent of the discrete, cyanate ester phase is reduced and the ability to maintain mechanical properties such as storage modulus are reduced as temperature increases. Therefore, the amount of poly(acrylonitrile-co-butadiene) is preferably no more than about 20 wt. % of the total weight of poly(acrylonitrile-co-butadiene) and cyanate ester(s).

In at least one embodiment of the current invention, the cured composition, typically without filler, forms an electrically insulating dielectric material with a dielectric loss tangent less than 0.015. For many electronic applications it is desirable to have a dielectric material with a lower CTE than those afforded by compositions having about 80 to about 91 wt. % cyanate ester and about 9 to about 20 wt. % poly(acrylonitrile-co-butadiene). To reduce the CTE of the composition, inorganic fillers, such as silica (SiO₂), may be added. For example, as shown in Examples 11-18, infra, the addition of 68 wt. % silica filler reduces the CTE into a range where the cured composition is fairly well matched with various metals, especially copper, which has a CTE of 17 ppm/° C.

In at least one embodiment of the current invention, the cured composition, typically with filler, forms an electrically insulating dielectric material with a dielectric loss tangent less than 0.008, which is suitable for high frequency (>1 GHz) applications, and a coefficient of thermal expansion (CTE) less than 25 ppm/° C.

Methods of compatiblizing the inorganic filler with the cyanate ester and poly(acrylonitrile-co-butadiene) and/or solvents utilized to solvent coat the composition may be employed as long as they do not significantly decrease the performances of the finished dielectric film. Suitable methods include the use of silane coupling agents, dispersing agents or surfactants.

Other additives may be used in the dielectric material, provided that they do not significantly interfere with the adhesion properties or the dielectric properties of the dielectric material. Useful additives include antioxidants, stabilizers, dyes, colorants, and the like. For example, stabilizers may inhibit or retard heat degradation, oxidation, and skin or color formation during processing steps that expose the material to high temperatures.

Articles of the present invention, including substrates and electronic packages, may include at least one conductive layer, and typically include multiple conductive layers with multiple interleaved dielectric layers. At least one of the dielectric layers or the core layer may contain the cured composition of the present invention. The conductive layer may be any suitable type of conductive material. Examples of suitable conductive materials included laminated low profile copper, plated copper, and sputtered aluminum. The conductive layer is typically less than about 40 μm thick, more typically 12 μm. In one embodiment the conductive layer(s) are formed from copper. Copper substrates are preferably thin, typically 5μm or less, with low profile surfaces. Copper foil this thin is a fragile material and is preferably mechanically supported on a carrier foil. The carrier foil is typically copper or aluminum and 30 to 40 μm thick. Copper foil manufacturers supply the thin copper foils on the carrier foils. In this form the thin copper foil can be coated with a primer, if necessary, and then coated with or laminated to dielectric layers made with, for example, the composition of the present invention. The dielectric layer can be used to bond the coated copper foil to an article or substrate. The carrier foil can be removed by simply peeling it away from the thin copper foil. The dielectric layer and article or substrate to which it is bound then provides the mechanical support for the thin copper. Depending on the nature of the dielectric material, it may have to be cured prior to the removal of the carrier foil to provide sufficient mechanical support for the thin copper foil. The thin copper foil may subsequently undergo further processing such as plating with additional copper to increase its thickness and patterning by known photolithographic and chemical etching techniques to provide a patterned electrical conductor.

To precision coat the composition, a solvent-containing mixture of the composition is coated onto the desired substrate and dried, preferably at elevated temperatures to remove the solvent. In one embodiment, a solvent-containing mixture of the composition is coated onto copper foil and then dried to remove the solvent. The dried coatings preferably have a thickness of between about 0.5 micrometer and about 100 micrometers. In some embodiments, the dielectric layer has a thickness of 25 μm or less. However, thicker layers, including those having thicknesses of 36 μm and 40 μm, may be useful for some applications. Curing the composition can be completed through baking or lamination. The lamination temperature will vary with the specific ingredients used. Alternatively, the mixture may be coated onto a release liner, such as poly(ethylene terephthalate) film with a silicone release agent on its surface, and then dried. The uncured composition then can be transferred to other substrates such as copper foil by methods such as hot roll lamination. Completed substrate structures may contain a single conductive layer with a layer of composition coated as described above or multiple conductive layers and cured composition.

Another aspect of the present invention is a multilayer electronic package having multiple conductive layers, at least one of which is a copper layer, and multiple dielectric layers, at least one of which comprises a cured composition having a dielectric constant less than about 3.5, and a dielectric loss of less than about 0.008, wherein the cured composition includes about 50 to about 75 wt. % of an inorganic filler based on the total weight of the cured composition, and about 80 to about 91 wt. % of a cyanate ester and about 9 to about 20 wt. % of a high molecular weight poly(acrylonitrile-co-butadiene) based on the total weight of the poly(acrylonitrile-co-butadiene) and cyanate ester. The conductive and dielectric layers may be independently continuous or patterned layers.

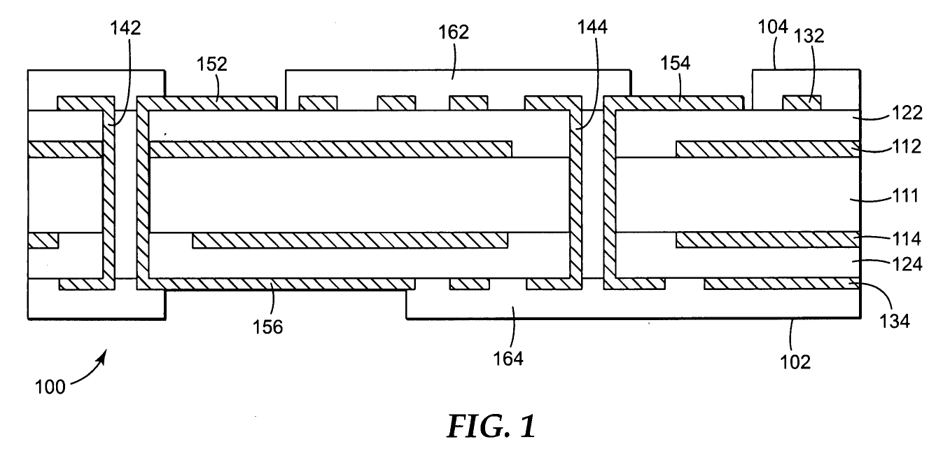

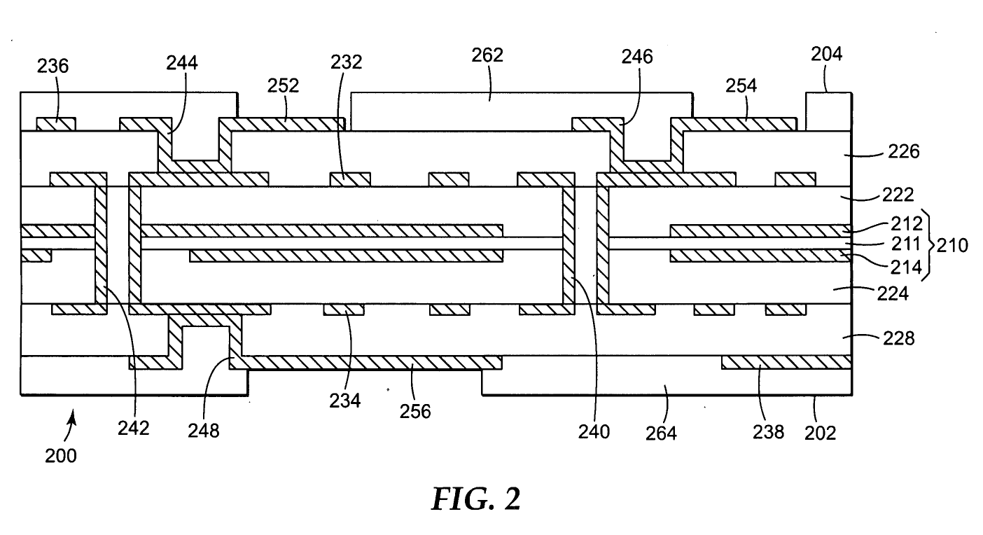

FIGS. 1 and 2 are exemplary embodiments of multilayer interconnect substrates that can be made with the composition of the current invention. These interconnect substrates are useful for packaging integrated circuit dies. Multiple dielectric layers can be formed from the composition.

FIG. 1 shows 4-metal layer interconnect substrate 100 made by laminating an alternating series of conductive (typically metal) layers 112, 114, 132 and 134; core layer 111; and dielectric layers 122 and 124. The conductive and dielectric layers shown in FIG. 1 are disposed symmetrically about core layer 111. By “disposed symmetrically”, it is meant that each dielectric or conductive layer formed on one side of core layer 111 has a corresponding layer of the same material formed on the opposite side of the core layer.

As further shown in FIG. 1, via 142 or 144 is used to interconnect the various metal layers. Via 142 extends through each of core layer 111 and dielectric layers 122, and 124 from conductive layer 132 and terminates at conductive layer 134. Each via 142, 144 is plated with conductive material using any of the deposition techniques that are known in the microelectronic fabrication art. In an alternative embodiment, each via 142, 144 may be filled with an electrically conductive material to define a conductive path. One skilled in the art will recognize that any combination of vias (through vias, blind vias and buried vias) may be used to provide electrical connections between the bond pads 152, 154 on die attach surface 104 and bond pad 156 on the ball grid array (BGA) attach surface 102.

Solder masks 162, 164 can be applied to die attach surface 104 and BGA attach surface 102. Each solder mask 162, 164 exposes a contact or bond pad adjacent to each via 142, 144. For example, solder mask 162 exposes contact pads 152, 154, whereas solder mask 164 exposes contact pads 156. Solder balls (not shown) associated with the chip can be aligned over contact pads, 152, 154, then heated, and reflowed to form an electrical and mechanical bond to the contact pads of the multilayer substrate and the chip. Likewise, solder balls (not shown) associated with the printed wiring board (PWB) can be aligned over contact pads 156, heated, and reflowed to form an electrical and mechanical bond between the contact pads and the PWB.

Core layer 111 may be conductive, non-conductive, or may include a combination of conductive and non-conductive materials. Suitable conductive materials include thick copper (e.g., up to ½ mm). Suitable non-conductive materials include the composite dielectric material of the invention, polyimide, glass, ceramics, inorganic dielectric materials, polymer/dielectric material blends, and the like. Suitable combination materials include flexible electrical circuits, capacitors, and printed wiring boards.

Dielectric layers 122 and 124 may be formed from individual layers of, or laminates of a combination of, high-temperature organic dielectric substrate materials, such as polyimides and polyimide laminates, epoxy resins, liquid crystal polymers (LCP), benzocyclobutene based polymers, a cured composition of the present invention, or dielectric materials comprised at least in part of polytetrafluoroethylene, with or without a filler. In one exemplary package design having a core layer and two dielectric layers, the non-conductive core layer may be composed of either a liquid crystal such as BIAC film (Japan Gore-Tex Inc., Okayama-Ken, Japan) or LCP CT film (Kuraray Co., Ltd., Okyama, Japan) or a polyimide film such as KAPTON H, K, or E (E. I. Du Pont de Nemours and Company) or a polyimide film sold under the trade name UPILEX (Ube Industries, Ltd.,) and the other two dielectric layers are composed of a cured composition of the present invention.

Conductive layers 112, 114, 132 and 134 may be formed from known conductive materials, such as copper. Other well-known conductive materials that may also be used include aluminum, gold, nickel, or silver. In at least one embodiment, conductive layers 112, 114, 132 and 134 may each have a thickness in the range of from about 5 to about 14 microns. In one exemplary package design, the thickness of each conductive layer 112, 114, 132 and 134, is approximately 12 microns. Core layer 111 may have a thickness in the range of at least about 1 micron to 750 microns. The remaining dielectric layers 122, 124 may each have a thickness in the range of about 20 to about 70 microns. In one example, the thickness of each dielectric layer 122, 124 is approximately 36 microns.

The various layers of interconnect substrate 100 can be stacked together and laminated using heat and pressure. For example, all of the layers can be simultaneously laminated with each other in a stack. Alternatively, the layers can be built upon a core layer 111 one at a time, or incrementally built with one or two additional layers added in each lamination step. During lamination, dielectric layers 122 and 124 may melt and flow, and in some cases, such as with the composition of the present invention, cure to provide a monolithic bulk dielectric material. The conductive layers can be patterned using standard known photolithography and etch methods.

Through vias can be formed following lamination of interconnect substrate 100. In particular, vias may be formed by drilling or laser ablation processes as described in U.S. Pat. No. 6,021,564, column 10, line 31 to column 31, line 10, incorporated herein by reference, or by chemical milling processes. Following lamination, solder masks 162 and 164 are added to interconnect substrate 100. Solder masks 162 and 164 may be patterned to define contact pads 152, 154 and 156 for receipt of solder balls from a chip and PWB, respectively.

In some embodiments (not shown in FIG. 1), interconnect substrate 100 may accept a “flip-chip” integrated circuit. Flip-chip mounting entails placing solder balls on a die or chip, flipping the chip over, aligning the chip with the contact pads on a substrate, such as interconnect module 100, and reflowing the solder balls in a furnace to establish bonding between the chip and the substrate. In this manner, the contact pads are distributed over the entire chip surface rather than being confined to the periphery as in wire bonding and tape-automated bonding (TAB) techniques. As a result, the maximum number of I/O and power/ground terminals available can be increased, and signal and power/ground interconnections can be more efficiently routed on the chips.

It should be recognized by those skilled in the art that interconnect substrates of the type disclosed herein may contain additional layers including embedded capacitor layers, conductive layers, dielectric layers, and the like. It is also possible to make interconnect substrates having fewer dielectric and conductive layers depending on the requirements of the final interconnect module.

FIG. 2 is a cross-sectional side view illustration of a multi-layer interconnect substrate 200, having six metal layers. The substrate has a die attach surface 204 and a board attach surface 202. It also includes a central capacitor structure 210 with first and second conductive layers 212, 214 and core layer 211.

Metal films, which may be coated with a dielectric material such as a composition of the present invention, are laminated to both sides of patterned capacitor structure 210. In the case of the composition of the present invention, the composition may cure during lamination. Subsequently, through vias 240, 242 are drilled and cleaned. Seed metal (not shown) is applied to the via(s) through electroless plating or sputtering or chemical vapor deposition, and then bulk metal is grown through electrolytic plating. Circuitry from the third and fourth conductive layers 232 and 234 is formed by standard techniques. Additional metal films coated with a dielectric material such as a composition of the present invention are then laminated to both sides of the build-up structure. Blind vias 244, 246, 248 are drilled. Seed metal is again applied, followed by bulk metal buildup. Surface circuitries 236, 238 are then formed through standard techniques. Protective coating 262 and 264, are finally applied and patterned to expose top contact pads 252, 254 and bottom electrical contact pads 256.

The core layer 211 of the capacitor structure may be formed by coating a high dielectric material on one or both of first and second conductive layers 212, 214 and then applying heat and pressure to laminate capacitor structure 210 and to cure the dielectric layer. First and second conductive layers 212, 214 can be formed of copper foils, and serve as power and ground planes. Conductive layers 212, 214 may each have a thickness of up to about 40 μm, preferably up to about 18 μm. Core layer 211 may be in the form of an epoxy resin loaded with high dielectric constant particles. The dielectric particles may be selected, for example, from barium titanate (including non-fired barium titanate) barium strontium titanate, titanium oxide, and lead zirconium titanate. A filled dielectric material of the present invention may also be suitable as a core layer of the capacitor structure.

Capacitor structure 210 is extremely thin and exhibits an extremely high dielectric constant. For example, the dielectric in the core layer 211, is typically formulated such that, upon curing, it has a total dry thickness of less than or equal to from about 10 to about 16 microns, preferably 8 microns and, more preferably, from about 1 to about 4 microns. In addition, the core layer has a high dielectric constant of greater than or equal to approximately 12 and, more preferably, from about 12 to about 150.

In addition, interconnect substrate 200 includes second and third dielectric layers 222, 224 on opposite sides of central capacitor structure 210. Third conductive layer 232 is formed between second dielectric layer 222 and fourth dielectric layer 226. Fourth conductive layer 234 is formed between third dielectric layer 224 and fifth dielectric layer 228. While first and second conductive layers 212, 214 may form power and ground planes, third and fourth conductive layers 232, 234 may be patterned to form signal layers. One or more of dielectric layers 222, 224, 226, 228 may be a dielectric material of the present invention.

Fourth dielectric layer 226 is formed over third conductive layer 232, whereas fifth dielectric layer 228 is formed over fourth conductive layer 234. Conductive layers 236, 238 can be formed on dielectric layers 226 and 228, respectively, and patterned to define preformed apertures for the formation of vias. The preformed apertures are typically formed by laser ablation. Thus, the laser used to form the vias is applied to ablate only the dielectric material.

Conductive layers 232, 234, 236, 238 all may be formed from copper with a thickness in the range of from about 5 to about 14 microns and, more preferably about 12 microns. Each of dielectric layers 222, 224, 226, 228 may have a thickness in the range of from about 20 to about 70 microns and, more preferably about 36 microns. Thus, the distance between an outer surface of first conductive layer 212 and an inner surface of electrical contact 252 is less than about 100 microns and, more preferably, less than or equal to about 88 microns. The various layers can be laminated together in a single step or through a sequential build-up. For example, prior to lamination, dielectric layers 222, 224 can be coated onto conductive layers 232, 234, respectively. These dielectric/conductive layer pairs can be laminated on either side of the central capacitor structure 210. The conductive layers 232 and 234 can be patterned to define signal traces. Similarly, dielectric layers 226, 228 can be coated onto conductive layers 236, 238, respectively, prior to lamination. These dielectric/conductive layer pairs can be laminated on to the outer surface of conductive layers 232 and 234, respectively. The conductive layers 236, 238 may then be patterned.

In some embodiments, the conductive layers are “balanced”, i.e., symmetrically positioned on opposite sides of capacitor structure 210 to promote structural uniformity and resist deformation due to thermal stresses. In particular, conductive layers may be constructed so that each has the same type of metal foil laminated or plated thereon and etched into a pattern across it; the metal concentration in each layer being approximately equal. In this manner, the CTE of one layer and the CTE of the other layer are substantially equal, thereby balancing one another and minimizing warp of the interconnect module under thermal stress.

For I/O interconnection, interconnect substrate 200 includes a number of conductive vias, such as buried through via 240, 242 which extend through dielectric layers 222, 224 and contact conductive layers 232, 234, which in turn, contact blind vias 244, 246, at the die attach surface 204 and blind via 248, at the board attach surface 202, respectively. Typically, blind vias are formed through only one dielectric layer and are used for routing connections between two conductive layers on either side of the dielectric layer. However, blind vias can be formed that extend through a plurality of laminated layers to connect multiple conductive layers on either side of the dielectric layer. Each of the conductive layers can be patterned as required, and any necessary blind vias to connect adjacent conductive layers formed, before the remaining layers are bonded to the overall structure. For power and ground distribution buried through vias 240, 242 may contact either first conductive layer 212 or second conductive layer 214.

Blind vias 244, 246 are placed adjacent to contact pads 252, 254 for receiving solder balls (not shown) from a chip attached to interconnect substrate 200. The solder balls are heated and reflowed to form electrically conductive bonds with contact pads 252, 254 and are electrically connected to vias 244, 246, respectively, thereby interconnecting I/O's on the chip with I/O's on the interconnect substrate 200. Likewise, blind via 248 is adjacent to contact pad 256 to receive solder balls to provide electrical and mechanical connection of the interconnect substrate to the board. The solder balls are heated and reflowed to form conductive bonds with contact pad 256 and therefore are electrically connected to via 248, thereby interconnecting I/O's on the interconnect module with I/O's on the PWB. The blind and buried vias present a low inductance signal path, further reducing impedance in interconnect substrate 200.

### EXAMPLES

All percents, ratios and amounts in the text are by weight unless otherwise specified. All amounts in table are by weight percent unless otherwise noted.

Test Methods

Thermomechanical Analysis (TMA)

The CTEs of the materials were measured by TMA (using a TMA2940 apparatus commercially available from TA Instruments, New Castle, Del.). Films were measured under the tension mode (film/fiber mode). The films were run under 1MPA tension stress at 10° C./min heating rate. The experimental temperature range was set from −60 to 350° C. The CTE (coefficient of thermal expansion) values for the films were determined from −25 to 150° C. temperature range (or the linear slope of thermal expansion curves in the temperature ranges of interest). The glass transition temperature of the films was chosen as the cross point of two extrapolated linear lines, which were linear expansion lines of the films at glassy state and soften state.

Dynamic Mechanical Analysis (DMA)

The tensile storage modulus, E′, tensile loss modulus, E″ and glass transition of films were measured by DMA (using a DMS110 apparatus commercially available from Seiko Instruments, Chiba, Japan). The films were run under tension mode (film/fiber mode). The films were run under 1 Hz frequency at 2° C./min heating rate from 25 to 300° C. The modulus of films at any temperature could be obtained from the storage modulus curve. The glass transition temperature was chosen from the transition peak temperature of loss modulus curve.

Materials Used

| Trade | | | |
|---|---|---|---|
| Designation | Type of Material | Properties | Available from |
| 18,090-4 | poly(acrylonitrile- | High Mw; | Aldrich, |
| | co-butadiene) | Mooney viscosity of 42-52; | Milwaukee, WI |
| | | Acrylonitrile content of 30-35 wt. % | |
| Perbunan | poly(acrylonitrile- | Mooney viscosity (UML 1 + 4 | Bayer |
| NT3446VP | co-butadiene) | (100 C)) of 45 +/− 5; | Polymers, |
| | | Acrylonitrile content of 34.7 +/− 1.0 wt. % | (Rubber |
| | | | Division)Akron, |
| | | | OH. |
| Therban | fully hydrogenated | Mooney viscosity of 63; | Bayer Polymers |
| A3406 | poly(acrylonitrile- | Acrylonitrile content of 4 wt. % | |
| | co-butadiene)* | | |
| Krynac | poly(acrylonitrile- | Mooney viscosity of 45 +/− 5; | Bayer Polymers |
| 2745C | co-butadiene) | Acrylonitrile content of 26.7 +/− 1.5 wt. % | |
| BA-200 | prepolymer of | | Lonza, Basel, |
| | bisphenol A | | Switzerland |
| | dicyanate | | |
| xu71787.02L | dicyanate of the | | Huntsman |
| | bisphenol formed | | Chemicals |
| | by reaction of | | (formerly |
| | phenol with | | Vantico Inc.), |
| | dicyclopentadiene | | Brewster, NY |
| SO-E2 | silica filler | median particle diameter of | Tatsumori Ltd., |
| | | approximately 0.5 μm | Tokyo, Japan |
| PLV-3 | silica filler | median particle diameter of | Tatsumori Ltd. |
| | | approximately 3 μm | |

*the carbon double bonds in the butadiene repeat unit have been hydrogenated.

### Examples 1 and 2 and Comparative Examples 1 and 2

Polymer films were made with varying amounts of poly (acrylonitrile-co-butadiene) to cyanate ester. The amounts and types of materials for each example are shown in Table 1 below. The cyanate ester was a 50/50 w/w mixture of BA-200 and xu71787.02L.

TABLE 1

| | |
|---|---|
| poly(acrylonitrile- | |
| co-butadiene) | Cyanate Ester |
| (wt %) | (wt %) |

| Example | 18,090-4 | BA-200 | xu71787.02L |
|---|---|---|---|
| C1 | 5 | 47.5 | 47.5 |
| C2 | 8 | 46 | 46 |
| 1 | 9 | 45.5 | 45.5 |
| 2 | 10 | 45 | 45 |

Formulations of each composition were made by adding the poly(acrylonitrile-co-butadiene) and cyanate esters to a glass jar. Methyl ethyl ketone (MEK) was added to the glass jar in a weight equal to that of the combined weight of the poly(acrylonitrile-co-butadiene) and cyanate esters or in other words to provide 50 wt. % solids. The jar was capped and placed on a pair of rollers, which mixed the contents by rolling the jar. The poly(acrylonitrile-co-butadiene) and cyanate esters dissolved in typically 2 - 5 days to form the resin solution.

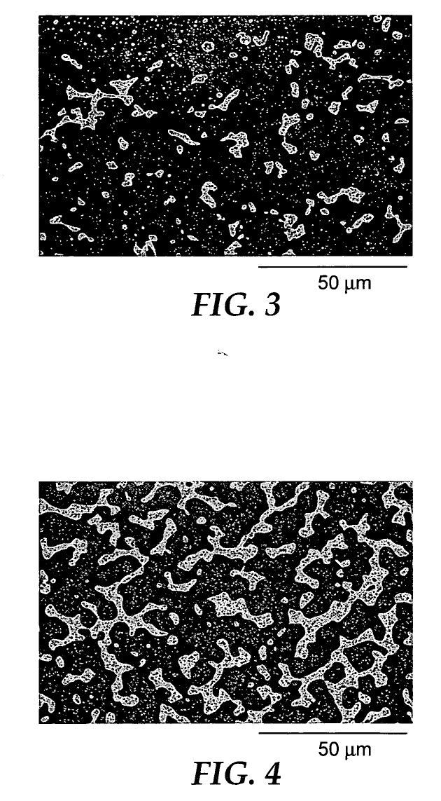

Films were made by adding 300 ppm Co based on the total solids to the resin solution in the form of cobalt (III) acetylacetonate (Co(AcAc)₃, available from Strem Chemicals, Newburyport, Mass.). The Co(AcAc)₃ and resin solution were added to a mixing cup and mixed four successive times at 3000 rpm for 1 minute each time with a mixer having the trade designation FLACKTEK DAC 150 SPEED MIXER, manufactured by Hauschild, Hamm, Germany, and available from FlackTek, Inc., Landrum, S.C. The Co was added to catalyze the trimerization reaction of the cyanate ester, which occurs in a subsequent curing process. The solutions were then cast into films by coating the solutions onto a polyimide film available under the trade designation UPILEX 25S from Ube Industries, Ltd., Japan with a film casting knife obtained from BYK-Gardner USA, Columbia, Md. The coatings were allowed to air dry at room temperature for 1 hour, and then were heated under nitrogen purge to 70 C and held for 1 hour, and then heated under nitrogen purge to 110 C and held for 1 hour to further dry. The dried, uncured films were clear to the eye. The films were then cured for 3 hours at 177° C. then 2 hours at 232° C. under nitrogen. The films became cloudy or hazy upon curing, which indicated phase separation had occurred. The films were 100 - 200 microns in thickness. FIGS. 3, 4, 5, and 6 show scanning electron micrographs of the films of Comparative Examples 1 and 2 and Examples 1 and 2, respectively.

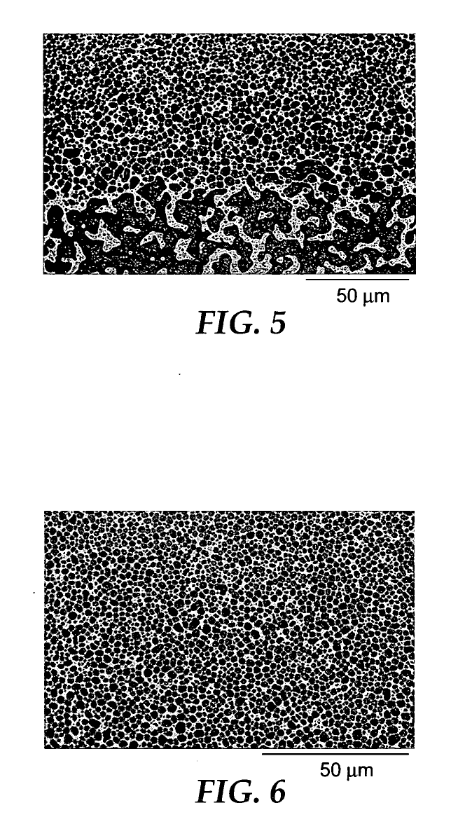

The films were stained with Osmium Tetroxide (OSO₄), which preferentially reacts with the carbon-carbon unsaturated bonds in the poly(acrylonitrile-co-butadiene). The samples were imaged using backscattered electron imaging, and thus areas with higher concentration of the poly(acrylonitrile-co-butadiene) appear lighter. As can be seen in FIGS. 3 and 4, for Comparative Examples 1 and 2, at 5 and 8 wt. % poly(acrylonitrile-cobutadiene), the morphology of the cured films consisted of a continuous cyanate ester phase and a discrete poly(acrylonitrile-co-butadiene) or poly(acrylonitrile-cobutadiene)/ cyanate ester phase. As can be seen in FIG. 5, for Example 1, at 9 wt. % poly(acrylonitrile-co-butadiene), two morphologies can be seen in the sample. A small area of the sample has a morphology similar to that of the Comparative Example 2, with 8 wt. %, but the remaining area has a morphology in which the poly(acrylonitrile-co-butadiene)/cyanate ester phase is continuous and the cyanate ester phase is discrete. As can be seen in FIG. 6, for Example 2, at 10 wt. % poly(acrylonitrile-co-butadiene), the entire sample has the morphology in which the poly(acrylonitrile-co-butadiene)/cyanate ester phase is continuous and the cyanate ester phase is discrete.

### Example 3 and 4

Examples 3 and 4 were made in a manner similar to that of Examples 1 and 2 except the cyanate ester did not contain any BA-200. The final compositions of the samples are shown in Table 2 (not taking into account the small amounts of Cobalt):

TABLE 2

| | poly(acrylonitrile-co- | |
|---|---|---|
| | butadiene) | Cyanate Ester |
| | (wt %) | (wt %) |
| Ex. | 18,090-4 | xu71787.02L |
| 3 | 10 | 90 |
| 4 | 20 | 80 |

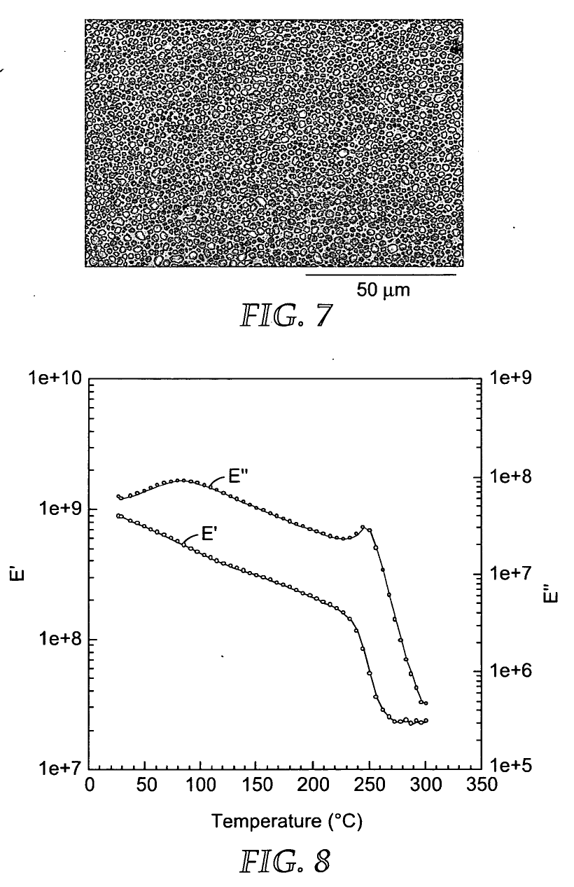

The morphology of Example 3 is shown in FIG. 7. The compositions of the two phases of the sample were estimated by DMA and TMA techniques, as described above. FIG. 8 shows the dependence of the tensile storage modulus and loss modulus of the cured 10/90 w/w Aldrich 18090-4/xu71787.02L sample of Example 3 versus temperature.

As shown in FIG. 8, the tensile storage modulus (E′) of the material gradually decreases with increasing temperature up to its upper Tg of 245° C., then falls off rapidly. Therefore, the material maintains fairly good mechanical properties up to 245° C., which is lo close to the Tg of the pure cyanate ester, xu71787.02L. The upper Tg is that of the discrete phase in the material. The composition of this discrete phase is roughly estimated to be 99 wt. % xu71787.02L and 1 wt. % Aldrich 18090-4 using Tg's of 250° C. and −27° C. for xu71787.02L and Aldrich 18090-4, respectively, in the following equation 1:
1/Tg=w₁/Tg₁+w₂/Tg₂ (eqn. 1)

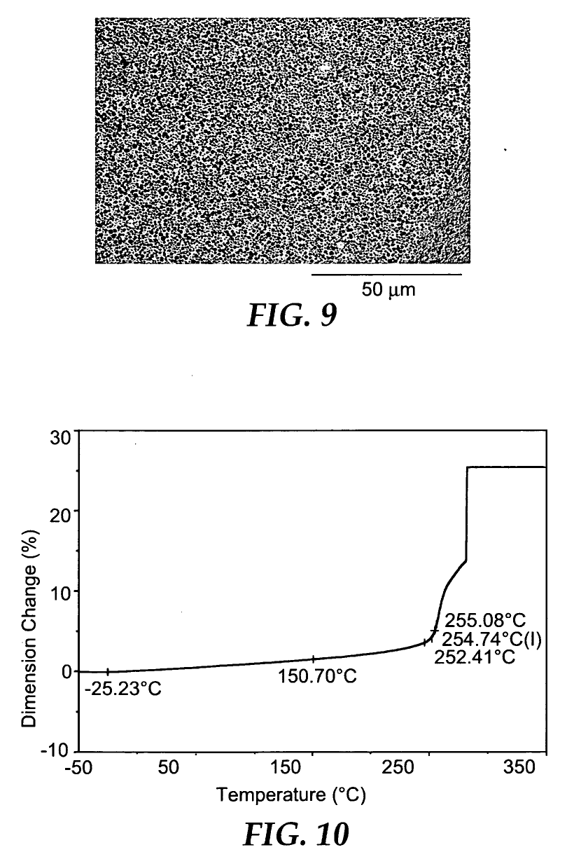

The plot of loss modulus (E″) versus temperature in FIG. 8 shows a broad peak centered at 85° C. in addition to the peak at 245° C. This broad peak appears to represent a lower Tg of the continuous phase. Again, using equation 1, the composition of the continuous phase is roughly estimated to be 59 wt. % xu71787.02L and 41 wt. % Aldrich 18090-4. Because the continuous phase is composed of almost all of the poly(acrylonitrile-co-butadiene) with the addition of some amount of cyanate ester, it would be expected that the volume of the continuous phase would be larger than that expected for the Aldrich 18090-4 alone. This increased volume can be seen in FIG. 7. The increased volume can more easily be seen for the composition of Example 4 in FIG. 9.

FIG. 10 illustrates the dimensional change versus temperature for the sample of Example 3. The measurements were taken using the Thermomechanical Analysis (TMA) described above. The results show a sharp increase in the rate of expansion of the material with temperature once the upper Tg is reached. No such change is seen at the lower Tg. The CTE of the material is 89.8 ppm/° C. from −25 to 150 C.

### Comparative Examples 3 and 4 and Examples 5 and 6

These examples show the CTE for cured compositions made of cyanate esters with and without poly(acrylonitrile-co-butadiene). Comparative Examples 3 and 4 and Examples 5 and 6 were made and cured in a manner similar to that of Examples 1 and 2. The compositions of the samples are shown in Table 3 (not taking into account the small amounts of Cobalt). The CTE's of the cured samples were determined for a −25° C. to 150° C. temperature range by the Thermomechanical Analysis described above and are shown in Table 3.

TABLE 3

| | poly(acrylonitrile- | | | |
|---|---|---|---|---|
| | co-butadiene) | Cyanate Ester | | |
| | (wt %) | (wt %) | | CTE |
| Example | 18,090-4 | BA-200 | xu71787.02L | (ppm/° C.) |
| C3 | — | — | 100 | 75 |
| C4 | — | 100 | — | 60 |
| 5 | 10 | — | 90 | 90 |
| 6 | 10 | 90 | — | 90 |

### Comparative Examples 5 and 6 and Examples 7-10

These examples show the dielectric constant and dielectric loss tangent for cured compositions made of cyanate ester with and without poly(acrylonitrile-co-butadiene). Comparative Examples 5 and 6 and Examples 7-10 were made and cured in a manner similar to that of Examples 1 and 2. The compositions of the samples are shown in Table 4 (not taking into account the small amounts of Cobalt). The dielectric constant (ξᵣ) and dielectric loss tangent (Tan δ) at 9.3 GHz of the cured samples are shown in Table 4. The dielectric measurements were done at room temperature with a split-post cavity resonator as described in NIST Technical Note 1512 Dielectric and Magnetic Properties of Printed Wiring Boards and Other Substrate Materials by James Baker-Jarvis, Bill Riddle, and Michael D. Janezic, National Institute of Standards and Technology; printed by U.S. Government Printing Office, Washington, D.C., 1999. Some error in the dielectric constant may be introduced if thickness across the sample is not exactly the same. This does not effect the determination of the dielectric loss tangent.

TABLE 4

| | poly(acrylonitrile- | | | | |
|---|---|---|---|---|---|
| | co-butadiene) | Cyanate Ester | | | |
| | 18,090-4 | BA-200 | xu71787.02L | | |
| Example | (wt %) | (wt %) | (wt %) | ξᵣ | Tan δ |
| C5 | — | — | 100 | 2.6 | 0.0031 |
| C6 | — | 100 | — | 2.8 | 0.0065 |
| 7 | 10 | — | 90 | 2.5 | 0.0075 |
| 8 | 20 | — | 80 | 2.6 | 0.0095 |
| 9 | 10 | 90 | — | 2.4 | 0.0098 |
| 10 | 20 | 80 | — | 3.0 | 0.0139 |

### Comparative Example 7 and 8 and Examples 11-18

These examples show the CTE for cured compositions made of cyanate ester blends with and without poly(acrylonitrile-co-butadiene) and with silica filler added. The examples are films composed of 68 wt. % silica filler and 32 wt. % of a poly(acrylonitrile-co-butadiene) and cyanate ester blends. Each example was a different combination of silica, poly(acrylonitrile co-butadiene), and cyanate ester.

Mixtures of BA-200 and xu71787.02L were used as the cyanate ester portion of the blends. The xu71787.02L helps to lower the overall dielectric loss tangent and the BA-200 prepolymer helps to increase the melt viscosity of the uncured resin.

300 ppm of Co from Co(AcAc)₃ based on the weight of the cyanate esters plus poly(acrylonitrile-co-butadiene) was added as the cyanate ester trimerization cure catalyst.

Formulations of each composition were made by adding Co(AcAc)₃, silica filler, MEK, and a solution that contained the appropriate poly(acrylonitrile-co-butadiene) and cyanate esters at 50 wt. % solids in MEK to a mixing cup. The resin solution was pre-made in a manner similar to that of Examples 1 and 2. The components were mixed four successive times at 3000 rpm for 1 minute each time with a FLACKTEK DAC 150 SPEED MIXER manufactured by Hauschild, Hamm, Germany, and available from FlackTek, Inc., Landrum, S.C. The dispersion was 57-60 wt. % solids. The dispersion was cast into films by coating, drying, and curing in a manner similar to that of Examples 1 and 2.

CTEs in the temperature range of −25° C. to 150° C. for the cured films were determined by TMA, as described above. The results are shown in Table 5, along with the compositions of each example.

TABLE 5

| | poly(acrylonitrile-co- | | | | | | |
|---|---|---|---|---|---|---|---|
| | butadiene) wt %* | | | Cyanate ester | | | |
| | | Perbunan | Therban | wt %* | | | CTE |
| Ex. | 18,090-4 | NT3446VP | A3406 | BA-200 | xu71787.02L | Silica type | (ppm/° C.) |
| C7 | — | — | — | 50 | 50 | SO-E2 | 18.1 |
| 11 | — | 10 | — | 45 | 45 | SO-E2 | 19.8 |
| 12 | — | 15 | — | 42.5 | 42.5 | SO-E2 | 17.6 |
| 13 | — | 20 | — | 40 | 40 | SO-E2 | 19.1 |
| 14 | — | — | 10 | 45 | 45 | SO-E2 | 15.9 |
| C8 | — | — | — | 50 | 50 | PLV-3 | 21.3 |
| 15 | 10 | — | — | 45 | 45 | PLV-3 | 21.1 |
| 16 | 15 | — | — | 42.5 | 42.5 | PLV-3 | 24.5 |
| 17 | 20 | — | — | 40 | 40 | PLV-3 | 20.5 |
| 18 | — | — | 10 | 45 | 45 | PLV-3 | 19.0 |

*weight % based on only the total weight of poly(acrylonitrile-co-butadiene) and cyanate ester

### Comparative Examples 9 and 10 and Examples 19-20

These examples show the tensile strain elongation at break for cured compositions made of cyanate ester blends with and without poly(acrylonitrile-co-butadiene) and with silica filler added. The examples are films composed of 68 wt. % silica filler and 32 wt. % cyanate ester blends with and without poly(acrylonitrile-co-butadiene). Comparative Examples 9 and 10 and Examples 19-20 were made and cured in a manner similar to that of Examples 11 -18. The compositions of the samples are shown in Table 6 (not taking into account the small amounts of Cobalt).

Tensile tests were performed according to ASTM Designation D 1708-02a on microtensile specimens, small dogbones, laser cut from some of the films. The films varied in thickness from about 100 to about 400 microns in thickness. The strain elongation to break was determined by direct measurement of the elongation of the specimen by laser measurement rather than the displacement of the grips. This avoids the possibility of including slippage of the specimen in the grips as part of the elongation of the specimen. As can be seen in Table 6, the tensile strain elongation to break for these highly filled cured films is low. However, the addition of 10 wt. % Aldrich 18090-4 poly(acrylonitrile-co-butadiene) to the cyanate ester increased the strain elongation to break. The value was roughly doubled with the addition of 10 wt. % poly(acrylonitrile-co-butadiene).

TABLE 6

| | poly(acrylonitrile- | | | | |
|---|---|---|---|---|---|
| | co-butadiene) | Cyanate Ester | | | Strain at |
| | (wt %)* | (wt %)* | | | Break |
| Ex. | 18,090-4 | BA-200 | xu71787.02L | Silica Type | (%) |
| C9 | — | 50 | 50 | SO-E2 | 0.3 |
| 19 | 10 | 45 | 45 | SO-E2 | 0.6 |
| C10 | — | 50 | 50 | PLV-3 | 0.4 |
| 20 | 10 | 45 | 45 | PLV-3 | 0.7 |

*weight % based on only the total weight of poly(acrylonitrile-co-butadiene) and cyanate ester

### Examples 21-26

These examples show the dielectric constant and dielectric loss tangent for cured compositions made of cyanate ester blends with and without poly(acrylonitrile-co-butadiene) and with silica filler added. The examples are films composed of 68 wt. % silica filler and 32 wt. % cyanate ester blends with and without poly(acrylonitrile-co-butadiene).

Examples 21-26 were made and cured in a manner similar to that of Examples 11 - 18. The compositions of the samples are shown in Table 7 (not taking into account the small amounts of Cobalt).

Table 7 shows the dielectric loss tangents at 9.3 GHz of the cured films. The dielectric measurements were done with a split-post cavity resonator at room temperature as described for Comparative Examples 5 and 6 and Examples 7-10. Some error in the dielectric constant may be introduced if thickness across the sample is not exactly the same. This does not effect the determination of the dielectric loss tangent.

TABLE 7

| | poly(acrylonitrile-co- | | | | | | | |
|---|---|---|---|---|---|---|---|---|
| | butadiene) (wt %)* | | | Cyanate ester | | | | |
| | | Therban | | (wt %)* | | Silica | | |
| Ex. | 18,090-4 | A3406 | Krynac 2745C | BA-200 | xu71787.02L | type | ξᵣ | Tan δ |
| 21 | 10 | — | — | 45 | 45 | PLV-3 | 3.1 | 0.0061 |
| 22 | 15 | — | — | 42.5 | 42.5 | PLV-3 | 2.9 | 0.0065 |
| 23 | 20 | — | — | 40 | 40 | PLV-3 | 2.7 | 0.0066 |
| 24 | — | 10 | — | 45 | 45 | PLV-3 | 3.0 | 0.0068 |
| 25 | — | 10 | — | 45 | 45 | SO-E2 | 2.6 | 0.0064 |
| 26 | — | — | 10 | 45 | 45 | SO-E2 | 2.9 | 0.0061 |

*weight % based on only the total weight of poly(acrylonitrile-co-butadiene) and cyanate ester

The examples have dielectric loss tangents of 0.006 to 0.007. Based on the dielectric loss tangents of comparable examples from Table 4, which do not have silica fillers, one would expect the dielectric material of Example 21 to have a loss tangent midway between 0.0075 and 0.0098. However, the dielectric material containing the silica filler has a loss tangent of 0.0061. Similarly, one would expect Example 23 to have a loss tangent midway between 0.0095 and 0.0139. The dielectric material containing the silica filler has a loss tangent of 0.0066.

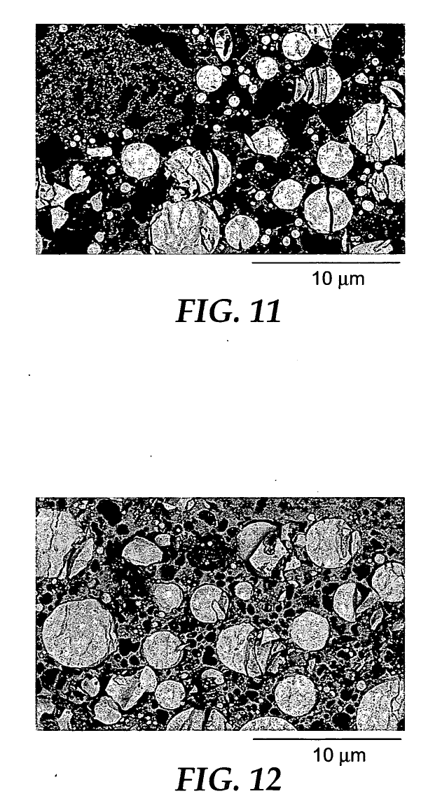

Digital images of SEM's of two cured dielectric materials having the same compositions as Examples 21 and 23, are shown in FIGS. 11 and 12, respectively. In the images, the lightest or white regions are silica, the light gray regions are the poly(acrylonitrile-co-butadiene)/cyanate ester phase, and the dark gray or black regions are the cyanate ester phase. The fracturing of some of the silica particles and pull out from the resin seen in the images occured during the cutting of the specimens with an ultramicrotome for SEM preparation.

Various modifications and alterations of this invention will become apparent to those skilled in the art without departing from the scope and spirit of this invention and it should be understood that this invention is not to be unduly limited to the illustrative embodiments set forth herein.

What is claimed is:

1. A composition comprising: a mixture of about 9 to about 20 wt % poly(acrylonitrile-co-butadiene) and about 80 to about 91 wt % cyanate ester of the total weight of the poly(acrylonitrile-co-butadiene) and cyanate ester.

2. The composition of claim 1 further comprising a filler.

3. The composition of claim 2 wherein the filler is silica.

4. The composition of claim 2 wherein the filler comprises at least 50 wt % of the composition.

5. The composition of claim 1 wherein the cyanate ester is a mixture of cyanate esters.

6. The composition of claim 1 wherein the poly(acrylonitrile-co-butadiene),is a mixture of poly(acrylonitrile-co-butadiene)s.

7. The composition of claim 1 wherein the poly(acrylonitrile-co-butadiene) is partially or fully hydrogenated.

8. The composition of claim 1 wherein the mixture is cured.

9. The composition of claim 8 further comprising a filler.

10. The composition of claim 9 wherein the filler is silica.

11. The composition of claim 9 wherein the filler comprises at least 50 wt % of the total weight of the composition.

12. An article comprising: a cured mixture having a continuous phase comprising poly(acrylonitrile-co-butadiene) and a discrete or co-continuous phase comprising cured cyanate ester.

13. The article of claim 12 wherein the continuous phase further comprises cured cyanate ester.

14. The article of claim 13 wherein the continuous phase further comprises silica.

15. The article of claim 12 wherein the discrete or co-continuous phase further comprises poly(acrylonitrile-co-butadiene).

16. The article of claim 12 wherein the cured composition is formed from a mixture comprising about 9 to about 20 wt % poly(acrylonitrile-co-butadiene) and about 80 to about 91 wt % cyanate ester based on the total weight of the poly(acrylonitrile-co-butadiene) and cyanate ester.

17. An article comprising: at least one dielectric layer comprising a cured mixture having a continuous phase comprising poly(acrylonitrile-co-butadiene) and a discrete or co-continuous phase comprising cured cyanate ester.

18. The article of claim 17 further comprising at least one conductive layer.

19. The article of claim 17 wherein the conductive layer is copper.

20. The article of claim 18 wherein the at least one conductive layer and at least one dielectric layer comprise an electronic package.

21. The article of claim 20 wherein the electronic package comprises a core layer.

22. The article of claim 21 wherein the core layer comprises a polymer selected from the group consisting of liquid crystal polymers and polyimide polymers.

23. The article of claim 21 wherein pairs of at least one conductive layer and at least one dielectric layer are disposed symmetrically about the core layer.
